(19) United States
(12) Patent Application Publication
(10) Pub. No.: US 2023/0365139 A1
(43) Pub. Date: Nov. 16, 2023

(54) SERVER AND METHOD FOR MANAGING NFT-BASED DRIVER DATA FOR AUTONOMOUS VEHICLE

(71) Applicant: HYUNDAI MOBIS Co., Ltd., Seoul (KR)

(72) Inventor: Byeong Hwan JEON, Yongin-si (KR)

(73) Assignee: HYUNDAI MOBIS Co., Ltd., Seoul (KR)

(21) Appl. No.: 18/075,702

(22) Filed: Dec. 6, 2022

(30) Foreign Application Priority Data
May 11, 2022 (KR) 10-2022-0057927

(51) Int. Cl. B60W 40/09; B60W 60/00; G06Q 30/0283

(52) U.S. Cl. CPC B60W 40/09; B60W 60/00; G06Q 30/0283; B60W 2050/0062; B60W 2756/10

(57) ABSTRACT

A method for managing NFT-based driver data for an autonomous vehicle includes: receiving driver data including driver’s driving information, traveling information and environment information transmitted from the autonomous vehicle; determining whether an autonomous driving algorithm applied to the autonomous vehicle is improvable based on the driver data; improving the autonomous driving algorithm based on the driver data based on a determination result; generating NFT data corresponding to the driver data as the autonomous driving algorithm is improved; and registering the NFT data in an NFT market for an autonomous vehicle.

### CROSS-REFERENCE TO RELATED APPLICATION

This application claims priority to and the benefit of Korean Patent Applications Nos. 10-2022-0057927, filed on May 11, 2022 in the Korean Intellectual Property Office, the disclosures of which are incorporated herein by references in their entirety.

### BACKGROUND

### 1. Technical Field

The present disclosure relates to a server and method for managing NFT-based driver data for an autonomous vehicle.

### 2. Related Art

Autonomous vehicles autonomously drive to a preset destination by recognizing the surrounding environment while driving and determining driving conditions to control the vehicle without driver intervention.

Recently, autonomous vehicles have received great attention as a means of transportation that can reduce traffic accidents and increase traffic efficiency, as well as improve passenger convenience, and research and development related thereto has been actively conducted.

Meanwhile, a scheme generally used to improve the performance of an autonomous driving algorithm applied to an autonomous vehicle is to secure as much raw data as possible and learn the secured raw data to generate general learning data.

In addition, when raw data for all situations cannot be secured, the autonomous driving algorithm is improved through data for exceptional situations occurring during driving and driver operation information at this time.

However, it takes a lot of cost and time to obtain driver’s operation information by setting all the exceptional situations, and it is practically impossible to implement it by reflecting all complex factors of the exceptional situation such as time, place, and weather.

Therefore, there is a need to create an environment in which driver data for various exceptional situations can be easily obtained from numerous autonomous vehicle drivers and the driver data can be collected more actively by providing a corresponding compensation to the driver.

### SUMMARY

The present disclosure has been made in an effort to solve the problems in the related art, and an object of the present disclosure is to provide a server and method for managing NFT-based driver data for an autonomous vehicle, which can easily obtain training data for an autonomous driving algorithm for an autonomous vehicle by collecting driving information, traveling information, and environment information when the driver intervenes in the autonomous vehicle, and manage the training data as NFT data to facilitate the management of verification of ownership, sales and transfer of the generated driver data.

However, objects to be achieved by the present disclosure are not limited to the object described above, and other objects may exist.

Various embodiments are directed to a method of managing NFT-based driver data for an autonomous vehicle, which includes: receiving driver data including driver’s driving information, traveling information and environment information transmitted from the autonomous vehicle; determining whether an autonomous driving algorithm applied to an autonomous vehicle is improvable based on the driver data; improving the autonomous driving algorithm based on the driver data based on a determination result; generating NFT data corresponding to the driver data as the autonomous driving algorithm is improved; and registering the NFT data in an NFT market for an autonomous vehicle.

Various embodiments are directed to a server for managing NFT-based driver data for an autonomous vehicle, which includes: a communication unit configured to transmit or receive data to and from an autonomous vehicle; a control unit configured to determine whether an autonomous driving algorithm applied to the autonomous vehicle is improvable based on driver data including driver’s driving information, traveling information and environment information transmitted from the autonomous vehicle through the communication unit, when receiving the driver data; an autonomous driving algorithm improvement unit configured to improve the autonomous driving algorithm based on the driver data based on a determination result; an NFT data generation unit configured to generate NFT data corresponding to the driver data as the autonomous driving algorithm is improved; and an NFT market management unit configured to register the NFT data in an NFT market for an autonomous vehicle.

To achieve the above-described objects, according to still another aspect of the present disclosure, a computer program may execute the server and method for managing NFT-based driver data for an autonomous vehicle in combination with a computer which is hardware, and stored in a computer-readable recording medium.

Other specific details of the present disclosure are included in the detailed description and drawings.

According to the embodiments of the present disclosure described above, it is possible to easily obtain driver data for exceptional situations from numerous autonomous vehicle drivers, and generate and manage the driver data as NFT data, thereby motivating the driver to provide driver data.

Accordingly, drivers can generate revenue from driver data they have registered, and companies that provide autonomous driving algorithms can improve autonomous driving algorithms while minimizing the cost of acquiring driver operation information in unpredictable situations.

In addition, a purchaser who purchases NFT data can expect an increase in the value of NFT according to the safety contribution of driver data related to the NFT data.

The effects of the present disclosure are not limited to the aforementioned effects, and other effects, which are not mentioned above, may be clearly understood by those skilled in the art to which the present disclosure pertains from the following descriptions.

### BRIEF DESCRIPTION OF THE DRAWINGS

FIG. 1 is a block diagram illustrating the concept of an entire system according to an embodiment of the present disclosure.

FIG. 2 is a block diagram illustrating an autonomous driving integrated control unit of an autonomous vehicle according to an embodiment of the present disclosure.

FIG. 3 is a block diagram illustrating a driver data management server according to an embodiment of the present disclosure.

FIG. 4 is a flowchart illustrating a driver data management method according to an embodiment of the present disclosure.

FIG. 5 is a flowchart illustrating an NFT data management method according to an embodiment of the present disclosure.

### DETAILED DESCRIPTION

The advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided to making the present disclosure complete and fully convey the scope of the present disclosure to a person with ordinary skill in the art. The present disclosure will be defined only by the scope of the appended claims.

Meanwhile, the terms used in the present specification are for explaining the embodiments, not for limiting the present disclosure. Unless particularly stated otherwise in the present specification, a singular form also includes a plural form. The terms “comprise” and/or “comprising” used in the specification are intended to specify the presence of the mentioned constituent elements, but do not exclude the presence or addition of one or more other constituent elements. Throughout the present specification, like reference numerals indicate like elements, and the term “and/or” indicates each of listed components or various combinations thereof. Terms, such as “first”, “second”, and the like, are for discriminating various components, but the components are not limited by the terms. The terms are used for discriminating one component from another component. Therefore, a first component mentioned below may be a second component within the technical spirit of the present disclosure.

Unless otherwise defined, all terms used herein (including technical or scientific terms) have the same meanings as those generally understood by those skilled in the art to which the present disclosure pertains. Such terms as those defined in a generally used dictionary are not to be interpreted as having ideal or excessively formal meanings unless defined clearly and specifically.

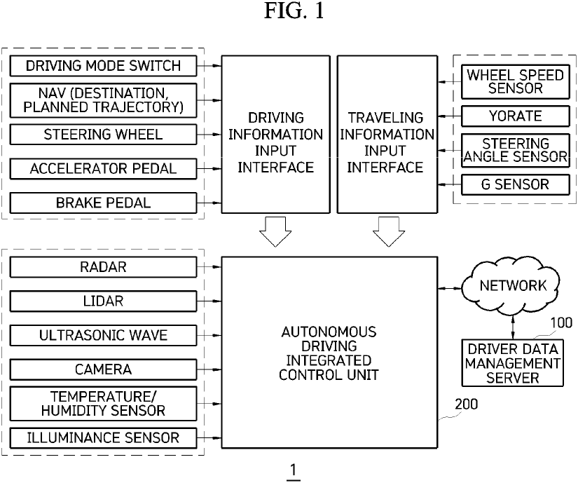

Hereinafter, an NFT-based driver data management server 100 for an autonomous vehicle according to an embodiment of the present disclosure will be described with reference to FIGS. 1 to 3.

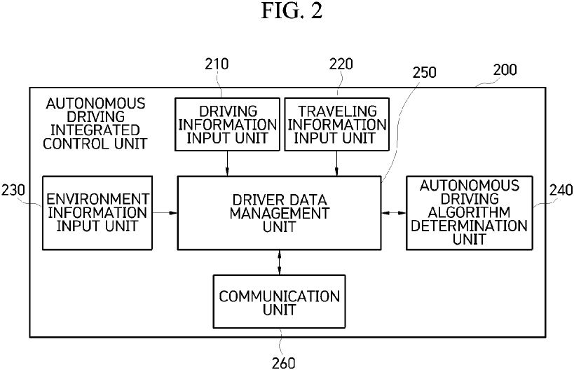

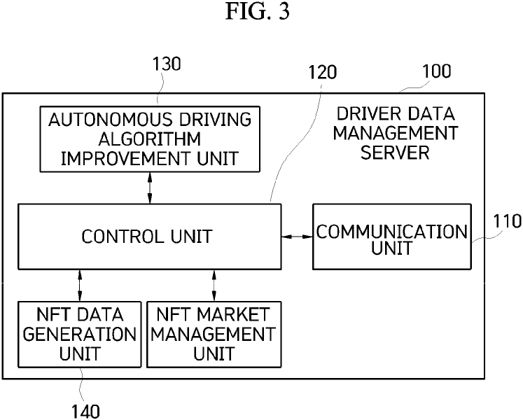

FIG. 1 is a block diagram illustrating the concept of an entire system 1 according to an embodiment of the present disclosure. FIG. 2 is a block diagram illustrating an autonomous driving integrated control unit 200 of an autonomous vehicle according to an embodiment of the present disclosure. FIG. 3 is a block diagram illustrating a driver data management server 100 according to an embodiment of the present disclosure.

Referring to FIG. 1, the entire system 1 according to an embodiment of the present disclosure includes the driver data management server 100 and an autonomous vehicle. The autonomous vehicle receives driver’s driving information, vehicle traveling information, and environment information through various sensors through the autonomous driving integrated control unit 200.

The driver data management server 100 is connected to the autonomous vehicle through a network to transmit or receive data. That is, the driver data management server 100 may receive each piece of information collected from the autonomous vehicle and distribute the improved version to the autonomous vehicle when the autonomous driving algorithm is improved. In addition, the driver data management server 100 may transmit or receive various data.

Referring to FIG. 2, when a driver intervention occurs during autonomous driving, the autonomous driving integrated control unit 200 of the autonomous vehicle generates corresponding information as driver data and transmits it to the driver data management server 100.

In addition, when the autonomous driving algorithm is improved and distributed and applied by the driver data management server 100, the autonomous driving integrated control unit 200 may transmit, to the driver data management server 100, whether autonomous driving is safely performed through the autonomous driving algorithm in exceptional situations.

The autonomous driving integrated control unit 200 includes a driving information input unit 210, a traveling information input unit 220, an environment information input unit 230, an autonomous driving algorithm determination unit 240, a driver data management unit 250, and a communication unit 260.

According to an exemplary embodiment of the present disclosure, the autonomous driving integrated control unit 200 may include a processor (e.g., computer, microprocessor, CPU, ASIC, circuitry, logic circuits, etc.) and an associated non-transitory memory storing software instructions which, when executed by the processor, provides the functionalities of the driving information input unit 210, the traveling information input unit 220, the environment information input unit 230, the autonomous driving algorithm determination unit 240, the driver data management unit 250, and the communication unit 260. Herein, the memory and the processor may be implemented as separate semiconductor circuits. Alternatively, the memory and the processor may be implemented as a single integrated semiconductor circuit. The processor may embody one or more processor(s).

The driving information input unit 210 receives autonomous driving information, route information, and operation information on steering, accelerator pedal, deceleration pedal, and the like according to driving mode switching of the driver.

The traveling information input unit 220 receives dynamics information during driving of the autonomous vehicle from a wheel speed sensor, a yaw rate sensor, a steering angle sensor, a gyro sensor, and the like of the autonomous vehicle.

The environment information input unit 230 receives information sensed during the operation of the autonomous vehicle from a radar, a lidar, an ultrasonic wave, a camera, a temperature and humidity sensor, an illuminance sensor, and the like.

The autonomous driving algorithm determination unit 240 provides the driver data management unit 250 with the determination result of the autonomous driving algorithm applied to the autonomous vehicle.

The driver data management unit 250 determines whether the driver intervenes through the determination result of the autonomous driving algorithm and driving information, and specifies the situation at the time of the intervention. In addition, when the driver’s intervention occurs, the driver data management unit 250 generates driver data including the driver’s driving information, the traveling information, and the environment information transmitted from the autonomous vehicle. In this case, the driver data may also include driver information for generating NFT data later.

The communication unit 260 communicates with the driver data management server 100 to transmit the driver data, and receives an improved autonomous driving algorithm.

Meanwhile, according to an embodiment of the present disclosure, the driver data is collected to be used as learning data for an autonomous driving algorithm. According to an embodiment, the driver data may be generated upon driver intervention even when the autonomous driving is in a normal mode or an autonomous driving mode.

According to an embodiment, the driver data is preferably generated in an exceptional situation and transmitted to the driver data management server 100, but the embodiment is not necessarily limited thereto. In this case, the exceptional situation may mean a situation not defined in the autonomous driving algorithm. Whether the situation is an exception may be determined based on driver data previously learned by the autonomous driving algorithm, that is, at least one of the driving information, traveling information and environment information.

For example, when there is a risk factor such as black ice in the front of a vehicle during autonomous driving, but no sensors of the vehicle detect it, the driver may intervene and drive to recognize and avoid the front risk factor. In this case, the autonomous driving integrated control unit 200 may generate, as driver data, environment information such as temperature and humidity of a situation in which the driver intervenes, environment information such as a front camera image, driver’s driving information, and vehicle traveling information, and transmit the driver data to the driver data management server 100 (first example).

For example, when a situation occurs during autonomous driving, in which it is difficult to secure a driving field of view and a sudden change in air quality due to a building collapse, an earthquake, a rupture of a water pipeline, and the like, the driver may directly drive by recognizing a dangerous situation. In this case, the autonomous driving integrated control unit 200 may generate, as driver data, environment information such as illuminance, humidity, camera, lidar, and radar information of a situation in which the driver intervenes, driver’s driving information, and vehicle traveling information, and transmit the driver data to the driver data management server 100 (second example).

For example, when a natural disaster such as a forest fire or tsunami occurs during autonomous driving, the driver may recognize a dangerous situation and directly drive. In this case, the autonomous driving integrated control unit 200 may generate, as driver data, environment information such as illuminance, temperature, camera, and radar information of a situation in which the driver intervenes, the driver’s driving information and the vehicle traveling information, and transmit the driver data to the driver data management server 100 (third example).

As such, an embodiment of the present disclosure can process and collect, as driver data, various types of information about exceptional situations that are generally difficult to assume, thereby using the driver data as training data for learning an autonomous driving algorithm.

Next, referring to FIG. 3, the driver data management server 100 collects driver data from each autonomous vehicle to improve the autonomous driving algorithm, and distributes an improved autonomous driving algorithm to the autonomous vehicle.

In addition, the driver data management server 100 may generate non-fungible token (NFT) data corresponding to the driver data collected in this process, register the NFT data in an NFT market, and readjust the value of the NFT data according to a contribution of the registered NFT data.

The driver data management server 100 according to an embodiment of the present disclosure includes a communication unit 110, a control unit 120, an autonomous driving algorithm improvement unit 130, an NFT data generation unit 140, and an NFT market management unit 150.

The communication unit 110 transmits or receives data to or from the autonomous vehicle. In addition, the communication unit 110 transmits or receives data to or from an NFT market server (not shown). Meanwhile, in the description of the present disclosure, it is described that the driver data management server 100 and the NFT market server are configured as independent servers, but the present disclosure is not necessarily limited thereto. Of course, according to an embodiment, the driver data management server 100 and the NFT market server may be implemented in a form in which independent programs are installed into one server computer.

The control unit 120 receives driver data including the driver’s driving information, traveling information, and environment information transmitted from the autonomous vehicle through the communication unit 110, and determines whether the autonomous driving algorithm applied to the autonomous vehicle is improvable based on the driver data.

In this case, the control unit 120 may receive the driver data from the autonomous vehicle when the driver data generated in the state in which the autonomous driving function of the autonomous vehicle is released is different from a determination result of an autonomous driving algorithm in the environment information.

Alternatively, the control unit 120 may receive the driver data from the autonomous vehicle when there is no illegality and no accident in the driving situation according to the driver data.

To the contrary, the control unit 120 may not apply the above condition when receiving driver data from the autonomous vehicle, but apply the above condition when determining whether the autonomous driving algorithm is improvable after receiving the driver data, so that it is possible to filter the driver data.

The control unit 120 may determine whether the autonomous driving algorithm applied to the autonomous vehicle is improvable based on the received driver data. In this case, the control unit 120 may apply, as a determination condition, whether the driver data is applicable to the autonomous driving algorithm, whether the safety level is increased when applicable, and whether the driver data is different from the previously learning data.

The autonomous driving algorithm improvement unit 130 improves the autonomous driving algorithm based on driver data according to the determination result of the control unit 120. After the autonomous driving algorithm is improved, an improved autonomous driving algorithm may be distributed to each autonomous vehicle through the communication unit 110.

The NFT data generation unit 140 generates NFT data corresponding to the corresponding driver data as the autonomous driving algorithm is improved. The NFT market management unit 150 registers the NFT data in the NFT market for an autonomous vehicle to enable the transaction of the NFT data.

As described above, according to an embodiment of the present disclosure, it is possible to learn the autonomous driving algorithm by configuring learning data in various exceptional situations through driver data collected from autonomous vehicles.

In addition, by composing driver data as NFT data and registering it in the NFT market to enable a transaction, it is possible to provide a corresponding compensation to the driver who provides driver data for an exceptional situation.

In addition, according to an embodiment of the present disclosure, by composing driver data as NFT data, it is possible to clearly verify the ownership of driver data and to allow the first owner to expect profits from the sale of NFT data and subsequent owners to expect profits from the transaction.

In addition, the owner of the NFT data may receive a predetermined dividend from an autonomous vehicle company when the autonomous driving algorithm is updated through the corresponding driver data or when the autonomous driving algorithm is distributed to an autonomous vehicle. In this case, the dividend may be determined based on the contribution of the driver data to the improvement of the autonomous driving algorithm.

As an embodiment, the control unit 120 may distribute an autonomous driving algorithm, improved based on driver data, to another autonomous vehicle through the communication unit 110. In addition, the control unit 120 may readjust, through the NFT market management unit 150, the value of NFT data registered in the NFT market on the basis of the contribution of the driver data to the autonomous driving algorithm in the another autonomous vehicle.

In detail, the control unit 120 collects traveling information and environment information when there is no accident and illegality during autonomous driving of another autonomous vehicle on the basis of the autonomous driving algorithm distributed through the communication unit 110, and determines whether driver data that matches the traveling information and environment information exists in the autonomous driving algorithm.

As a determination result, when the driver data exists, the control unit 120 may retrieve NFT data corresponding to the driver data through the NFT market management unit 150, and then increase the contribution of the retrieved NFT data.

In this case, the contribution may be increased based on the number of other autonomous vehicles to which the distributed autonomous driving algorithm is applied, and the number of times of application of driver data to an autonomous driving algorithm, the driver data matching traveling information and environment information during autonomous driving of the other autonomous vehicles.

According to the contribution, the owner may receive a predetermined dividend through owning the NFT data. As an example, the dividend is paid based on the cost required for autonomous vehicle companies to improve the autonomous driving algorithm through driver data, or based on the payment cost according to the choice of a specific driver rather than distributing the autonomous driving algorithm in bulk. Alternatively, various methods such as payment based on the transaction fee of NFT data may be applied.

In the above-described examples of generating driver data, a case in which the contribution of NFT data increases will be described as follows.

As an example, when a risk factor such as black ice is identified in the front of another autonomous vehicle during autonomous driving of the another autonomous vehicle to which the improved autonomous driving algorithm is applied, the autonomous driving algorithm performs a maneuver to avoid it, and transmits to the driver data management server 100 whether to maneuver to avoid the front risk factor situation. Accordingly, the driver data management server 100 may confirm that the driver data for the black ice situation of the another autonomous vehicle has been applied to the autonomous driving algorithm, and may increase the contribution of the NFT data corresponding to the driver data (first example) .

As an example, when a situation occurs during autonomous driving of another autonomous vehicle to which the improved autonomous driving algorithm is applied, in which it is difficult to secure a driving field of view and a sudden change in air quality due to a building collapse, an earthquake, a rupture of a water pipeline, and the like, the autonomous driving algorithm transmits, to the driver data management server 100, the sudden change in air quality and whether to perform safe driving in the situation in which it is difficult to secure a driving field of view. Accordingly, the driver data management server 100 may confirm that driver data for the situation in which it is difficult for the another autonomous vehicle to secure a driving field of view has been applied to the autonomous driving algorithm, and may increase the contribution of NFT data corresponding to the driver data (second example).

As an example, when the occurrence of natural disasters such as wildfires, tsunamis, and the like is confirmed during autonomous driving of another autonomous vehicle to which the improved autonomous driving algorithm is applied, the autonomous driving algorithm transmits to the driver data management server 100 whether to perform safe driving in the event of a natural disaster. Accordingly, the driver data management server 100 may confirm that the driver data for the natural disaster situation of the another autonomous vehicle has been applied to the autonomous driving algorithm, and may increase the contribution of NFT data corresponding to the driver data (third example).

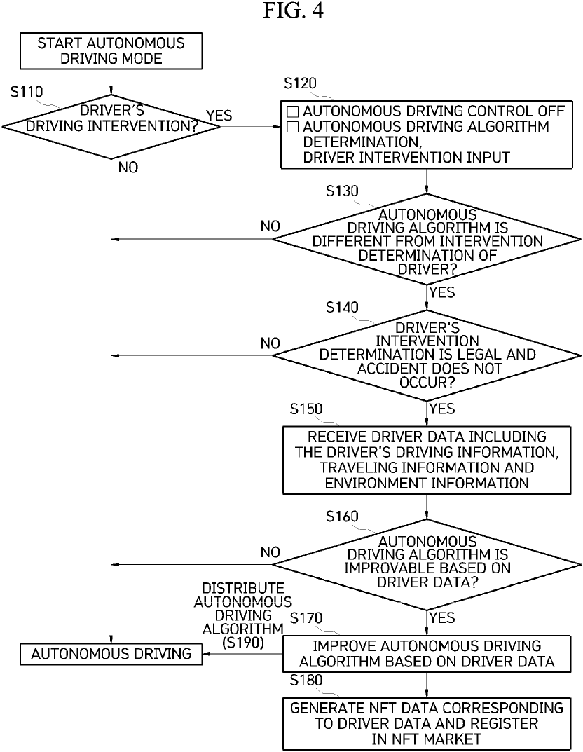

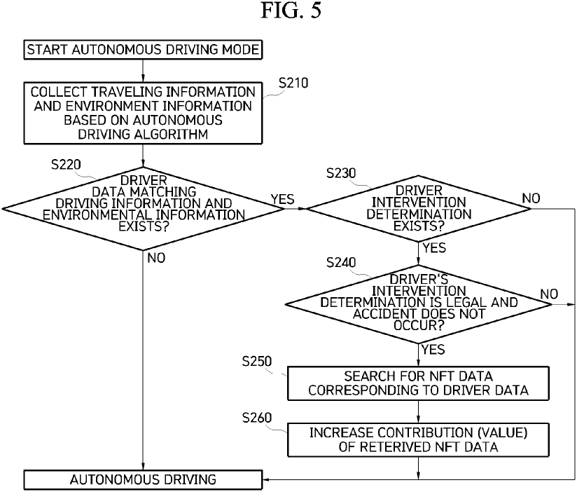

Hereinafter, a method performed by the driver data management server 100 according to an embodiment of the present disclosure will be described with reference to FIGS. 4 and 5.

FIG. 4 is a flowchart illustrating a driver data management method according to an embodiment of the present disclosure.

According to the driver data management method according to an embodiment of the present disclosure, first, in operation S110, it is determined whether there is driver intervention as the autonomous driving mode starts, and in operation S120, when the driver intervenes, the autonomous driving mode is turned off.

Next, when the determination of the autonomous driving algorithm is different from the intervention determination of the driver in operation S130, the intervention determination of the driver is legal and there is no accident in operation S140, the driver data including the driver’s driving information, traveling information and environment information transmitted from the autonomous vehicle is received in operation S150.

Next, it is determined in operation S160 whether the autonomous driving algorithm applied to the autonomous vehicle can be improved based on the received driver data, and in operation S170, the autonomous driving algorithm is improved based on the driver data according to the determination result.

Next, as the autonomous driving algorithm is improved, NFT data corresponding to the driver data is generated, and then the NFT data is registered in the NFT market for the autonomous vehicle in operation S180.

In addition, in operation S190, the improved autonomous driving algorithm is distributed and applied to the autonomous vehicle in real time or according to a preset period of time.

FIG. 5 is a flowchart illustrating an NFT data management method according to an embodiment of the present disclosure.

First, in operation S210, based on the distributed autonomous driving algorithm, the traveling information and environment information are collected during autonomous driving of another autonomous vehicle.

Next, it is determined in operation S220 whether there is driver data in the autonomous driving algorithm that matches the traveling information and environment information. As the determination result, when the driver data exists, there is no driver intervention determination in operation S230, and there is no accident and illegality in operation S240, the NFT data corresponding to the driver data is retrieved from the NFT market in operation S250.

Thereafter, as the NFT data is retrieved, the contribution (value) of the NFT data is increased in operation S260.

Meanwhile, in the above description, operations S110 to S260 may be further divided into additional steps or combined into fewer steps according to an implementation example of the present disclosure. In addition, some operations may be omitted if necessary, and the order between the operations may be changed. In addition, the contents of FIGS. 1 to 4 may also be applied to the contents of the driver data management method of FIGS. 5 and 6 even when other contents are omitted.

The driver data management method according to an embodiment of the present disclosure described above may be implemented as a program (or application) to be executed in combination with a computer which is hardware, and stored in a medium.

In order for the computer to read a program and execute the methods implemented by the program, the aforementioned program may include code coded in a computer language, such as C, C++, JAVA, Ruby, machine language, and the like, which can be read by a processor (CPU) of a computer through a device interface of the computer. Such code may include functional code related to a function or the like that defines the functions necessary to execute the methods, and may include an execution procedure related control code necessary for the processor of the computer to execute the functions according to a predetermined procedure. In addition, such code may further include memory reference related code for a location (address) of internal or external memory of the computer to which additional information or media necessary for the processor of the computer to execute the functions should be referred. In addition, when the processor of the computer needs to communicate with any other computer or server at a remote location in order to execute the functions, the code may further include communication-related code for how to communicate with any other remote computer or server using the communication module of the computer, and what information or media to transmit/receive during communication.

The storing medium means not a medium that stores data for a short time such as a register, a cache, a memory, and the like, but a medium that semi-permanently stores data and is capable of being read by a device. Specific examples of the storing medium include ROM, RAM, CD-ROM, magnetic tape, floppy disk, optical data storage, and the like, but are not limited thereto. That is, the program may be stored in various recording media on various servers to which the computer can access, or on various recording media on a user’s computer. In addition, the medium may be distributed throughout computer systems connected via networks and may store computer-readable code in a distributed manner.

The above description of the present disclosure is provided for illustrative purposes only, and it would be understood by those skilled in the art that the present disclosure may be easily modified into other various forms without changing technical spirit and essential features of the present disclosure. Thus, it should be understood that the above-described example embodiments are illustrative in all aspects and do not limit the present disclosure. For example, each component described to be in a single form can be implemented in a distributed manner. Likewise, components described to be distributed can be implemented in a combined manner.

The scope of the present disclosure is defined by the following claims rather than the above detailed description, and it should be interpreted that all changes or modified forms derived from the meaning and scope of the claims and equivalent concepts thereof are included in the scope of the present disclosure.

What is claimed is:

1. A method of managing NFT-based driver data for an autonomous vehicle, the method comprising:
receiving driver data including driver’s driving information, traveling information and environment information transmitted from the autonomous vehicle;
determining whether an autonomous driving algorithm applied to the autonomous vehicle is improvable based on the driver data;
improving the autonomous driving algorithm based on the driver data based on a determination result;
generating NFT data corresponding to the driver data as the autonomous driving algorithm is improved; and
registering the NFT data in an NFT market for the autonomous vehicle.

2. The method of claim 1, wherein the receiving of the driver data includes:
receiving the driver data when the driver data generated in a state in which an autonomous driving function of the autonomous vehicle is released is different from a determination result of the autonomous driving algorithm in the environment information.

3. The method of claim 1, wherein the receiving of the driver data includes:
receiving the driver data when there is no illegality and no accident in a driving situation according to the driver data.

4. The method of claim 1, further comprising:
distributing the autonomous driving algorithm, improved based on the driver data, to another autonomous vehicle; and
readjusting a value of NFT data, registered in the NFT market, based on a contribution of the driver data to the autonomous driving algorithm in the another autonomous vehicle.

5. The method of claim 4, wherein the readjusting of the value of the NFT data includes:
collecting traveling information and environment information of the another autonomous vehicle during autonomous driving of the another autonomous vehicle based on the distributed autonomous driving algorithm;
determining whether driver data of the another autonomous vehicle matching the traveling information and environment information of the another autonomous vehicle exists in the autonomous driving algorithm;
retrieving NFT data corresponding to the driver data of the another autonomous vehicle; and
increasing the contribution of the retrieved NFT data.

6. The method of claim 5, wherein the increasing of the contribution of the retrieved NFT data includes:
increasing the contribution based on a number of other autonomous vehicles to which the distributed autonomous driving algorithm is applied and a number of times of application of driver data of the other autonomous vehicles matching traveling information and environment information of the other autonomous vehicles.

7. A server for managing NFT-based driver data for an autonomous vehicle, the server comprising:
a communication unit configured to transmit or receive data to and from an autonomous vehicle;
a control unit configured to determine whether an autonomous driving algorithm applied to the autonomous vehicle is improvable based on driver data including driver’s driving information, traveling information and environment information transmitted from the autonomous vehicle through the communication unit, when receiving the driver data;
an autonomous driving algorithm improvement unit configured to improve the autonomous driving algorithm based on the driver data based on a determination result;
an NFT data generation unit configured to generate NFT data corresponding to the driver data as the autonomous driving algorithm is improved; and
an NFT market management unit configured to register the NFT data in an NFT market for the autonomous vehicle.

8. The server of claim 7, wherein the control unit is configured to receive the driver data through the communication unit when the driver data generated in a state in which an autonomous driving function of the autonomous vehicle is released is different from a determination result of the autonomous driving algorithm in the environment information.

9. The server of claim 7, wherein the control unit is configured to receive the driver data through the communication unit when there is no illegality and no accident in a driving situation according to the driver data.

10. The server of claim 7, wherein the control unit is configured to distribute the autonomous driving algorithm, improved based on the driver data, to another autonomous vehicle through the communication unit, and readjust, through the NFT market management unit, a value of the NFT data registered in the NFT market based on a contribution of the driver data to the autonomous driving algorithm in the another autonomous vehicle.

11. The server of claim 10, wherein the control unit is configured to collect traveling information and environment information of the another autonomous vehicle during autonomous driving of another autonomous vehicle based on the autonomous driving algorithm distributed through the communication unit, to determine whether driver data of the another autonomous vehicle matching the traveling information and environment information of the another autonomous vehicle exists in the autonomous driving algorithm, and retrieve NFT data corresponding to the driver data of the another autonomous vehicle through the NFT market management unit, and then increase a contribution of the retrieved NFT data.

12. The server of claim 11, wherein the NFT market management unit is configured to increase the contribution based on a number of other autonomous vehicles to which the distributed autonomous driving algorithm is applied and a number of times of application of driver data of the other autonomous vehicles to an autonomous driving algorithm, the driver data of the other autonomous vehicles matching the traveling information and environment information of the other autonomous vehicle.
